(19) United States
(12) Patent Application Publication
(10) Pub. No.: US 2004/0170026 A1
(43) Pub. Date: Sep. 2, 2004

(54) Motor vehicle license plate illuminated spacer

(76) Inventors: Charles Joseph Chip, Bend, OR (US); Charles Joseph Sweeney JR., Bend, OR (US)

Correspondence Address: CHARLES JOSEPH SWEENEY JR., 60991 SOUTH HIGHWAY 97, BEND, OR, 97703, US

(21) Appl. No.: 10/763,997

(22) Filed: Jan. 22, 2004

Related U.S. Application Data
(60) Provisional application No. 60/445,172, filed on Feb. 3, 2003.

(51) Int. Cl. B60Q 1/56

(52) U.S. Cl. 362/497

(57) ABSTRACT

A plastic plate to copy shape of motor vehicle license plate with regards to rounded corners, height, and lengths for a variety of license plate sizes. Thickness will vary and transparent colored edge of plastic spacer plate will be polished. Mounting holes of the spacer plate coincide with the mounting holes of various license plates. Subtle look of spacer plate in the daylight will be gem-like with a clean custom look. While at nighttime, under motor vehicle operation, the sandwiched spacer plate's edge will illuminate by the required license plate light. This added light at the rear of the vehicle will be beneficial for added nighttime visibility.

### BACKGROUND

1. Field of Invention

This idea of invention uses absorbed light for a spacer plate, mounted behind license plate, for added visibility and decoration.

2. Description of Prior Art

Street legal motorized vehicles are required to have light or lights to illuminate rear-mounted license plate. The required illuminated license plate helps identify vehicles operating in darkness. My idea for invention captures this light source through the polished transparent colored edge of Acrulite glass, sometimes referred to as plexiglass. This capture of light by the spacer plate's polished transparent edge is absorbed and now illuminated for added visibility in darkness, and providing a custom look.

Unlike other inventions such as Kevin VerKamps U.S. Pat. No. 5,521,799 U.S. classification 362/83.2. My idea requires no built-in or electrical apparatus, just colored light from other sources to illuminate.

Searching through other U.S. classification 358/1.2,40/209, 40/714, 40/546 I found nothing to my understanding of my idea for invention. Most of other inventions require electricity for their process to operate and cast light, whereas my idea collects light. Sun, or light of license plate light, cross traffic at nighttime, virtually any light source is absorbed through the polished transparent edge of the Aculite glass.

Noting that this spacer plate traces license plate being used with as regards to rounded corners, and size for different dimensions, for different states, and various vehicles used for.

When researching prior art relating to my idea, all need electric power to operate. This added power is a draw to vehicles limit for available electricity. To my knowledge, vehicles that are stock or custom can only handle so much output of electricity before strain is put on vehicle's electrical systems. My idea simply mounts behind license plate for a visually appealing and safer add-on, resulting in a cost-effective, decorative accessory, adding visibility under vehicle operation at night.

My spacer plate would simply mount the same as the license plate that is being used in conjunction with. For this reason, my idea of this spacer plate can vary with the size of license plate. For example, but not limited to motorcycle license plates. Motorcycle license plates can vary from state to state with subtle changes in size. Although most states in America use the same size plate, all are not the same. Even other countries' size of motorized vehicles license plates can differ in size.

Mounting of my spacer plate would simply use the same mounting holes used for the license plate it's being used with. This is possible because the predetermined license plates use a uniform drilling pattern. This uniform drilling of mounting holes creates a general pattern of different vehicle plates for an efficient method of mounting. My spacer plate would simply use the same measurements used for different size license plates for different motorized vehicles. These sizes vary, but not to the degree of making my spacer plate impossible to manufacture. Simple drilling jigs I have already built are used for various sizes of license plates. In a sense my spacer plate is a double of the required motor vehicle license plate it is used with.

### SUMMARY, RAMIFICATIONS AND SCOPE

Shown in these figures is the dimension of a 4″×7″ motorcycle license plate. These dimensions will vary with different sizes of motorized vehicle license plates. Mounting holes will also be variable according to license plate size.

With respect, the reader will see and take note of the uniqueness of this idea for invention as being novel, decorative, and a useful safety feature. Many variables of this idea of invention should be considered. Adding two or more spacer plates will consequently bring different effects to view. Many options are available with many colors to choose from to match consumers' taste. This one idea has virtually many combinations to choose from.

Therefore, the claims that follow will be the legalese, rather than the examples given above.

### DESCRIPTION OF FIGURES

FIG. 1 Shows the front and back view of the spacer plate with this example being of a 4″×7″ motorcycle license plate.

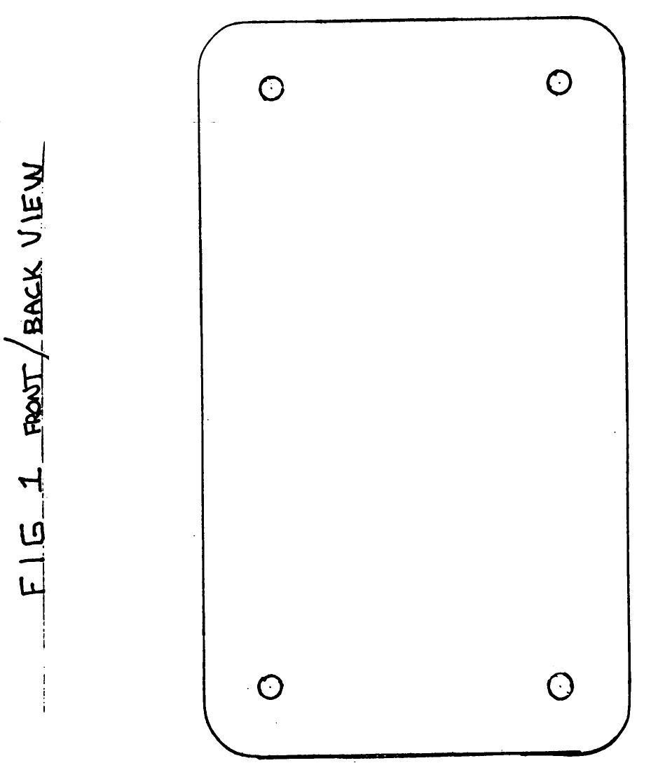

FIG. 2 Shows a side view of the spacer plate being used for a 4″×7″ motorcycle license plate.

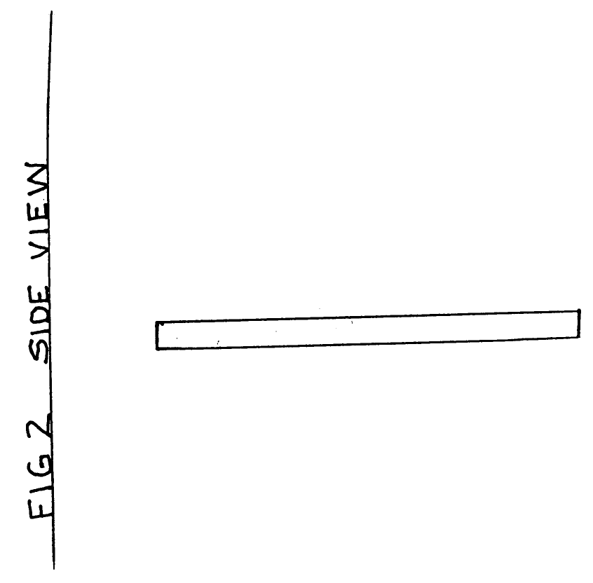

FIG. 3 Shows the top and bottom view of the spacer plate being used for a 4″×7″ motorcycle license plate.

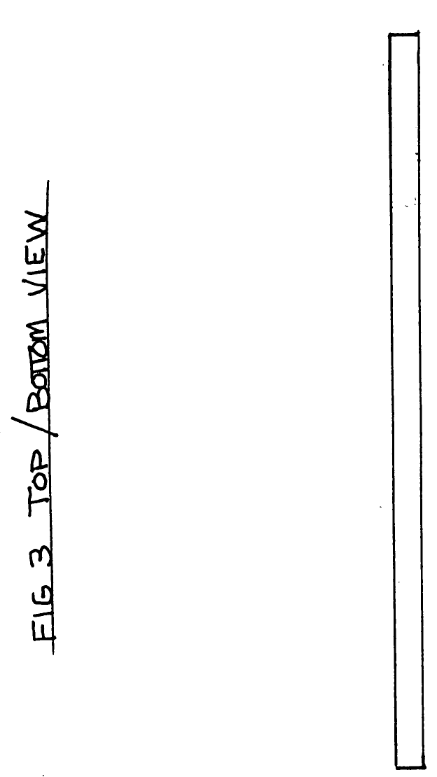

I claim:

1. That the spacer plate of Aculite glass, of different transparent colors sandwiched by motor vehicle license plate mount and license plate of the same size, will illuminate its edge by natural and electrically-required license plate light.

2. The illumination of said spacer plate edge in claim #1 shall occur by the polished effect of said spacer plate edge.

3. The said spacer plate of claim #1 is drilled through for mounting different dimensions of motor vehicle license plates of various sizes whereby license plate is mounted.

4. Thickness of transparent colored edge of said spacer plate of claim #1 shall vary whereby effects will differ.

5. The size of drilled mounting holes of said spacer plate of claim #3 shall vary in conjunction with size of motorized vehicle license plate mounting holes and distance.

6. Said spacer plate of claim #2's illumination will occur by sandwiching said spacer plate.
